(19) United States
(12) Patent Application Publication
(10) Pub. No.: US 2009/0119300 A1
(43) Pub. Date: May 7, 2009

(54) TECHNIQUE FOR EDITING CENTRALIZED DIGITALLY ENCODED INFORMATION

(75) Inventors: Girish Kumar Balachandran, Mountain View, CA (US); Christopher B. Webster, Dublin, CA (US); Todd Fast, San Francisco, CA (US); Jiri Kopsa, San Francisco, CA (US)

Correspondence Address: BROOKS KUSHMAN P.C. / SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 11/933,769

(22) Filed: Nov. 1, 2007

(51) Int. Cl. G06F 17/30

(52) U.S. Cl. 707/10; 707/E17.032

(57) ABSTRACT

A technique is disclosed herein for editing centralized digitally encoded content using a stateless client on a client machine. A repository on a central server is accessed by a user. The repository has a plurality of compilation units stored therein. One or more compilation units selected by the user are provided to the user via a stateless client on a client machine. The client is in communication with the repository over a network. Information associated with the one or more selected compilation units is programmatically sent to the repository at spaced time intervals.

### BACKGROUND OF THE INVENTION

1. Field of the Invention

The present invention relates to editing digitally encoded content and more particularly to editing centralized source code in a distributed environment.

2. Background Art

As computer-related projects become larger and more complicated, the efforts of a large number of individuals are often combined together to form the final product. Efficient development of such large projects requires facile access to the relevant files by individuals working on a project, as well as a system for tracking changes. Examples of such computer-related projects include, but are not limited to, source code, XML and HTML documents, website development, web services, and the like.

Currently, collaborative development environments allow multiple users to concurrently edit source code stored to a common, centralized location, such as on a web server. Many of these development environments are based on the fact that the client, where the source is being edited, has some type of state information about the code in their repository. A problem with this approach is that much of the detection and the resolution of conflicts is dealt with by the client's software on the client's system. This approach is susceptible to inconsistencies when different people are working on the same project on different computer systems and/or different geographical locations. Consequently, this approach may not work well for large projects, especially those in which multiple users require access to a centralized source repository from multiple client locations.

Accordingly, there is a need for collaborated development systems and methodology targeted to editing computer related projects, such as source code, in a centralized repository by a plurality of users in a distributed development environment.

### SUMMARY OF THE INVENTION

The present invention solves one or more problems of the prior art, by providing in at least one embodiment, a method for editing digitally encoded content (such as source code) located on a central server via a statement client on a client machine is provided. The method includes accessing by a user a digitally encoded content repository on the central server. The repository has a plurality of compilation units stored therein. A user is provided with one or more compilation units selected by the user via a stateless client on a client machine. The client is in communication with the repository over a network. Information associated with the one or more selected compilation units is programmatically sent to the repository at spaced time intervals. Advantageously, the present embodiment is useful for developing web services and other website related applications.

In another embodiment of the present invention, a system is provided for editing centralized digitally encoded content (e.g., source code). The system includes a content repository stored to a central server. The repository has a plurality of compilation units stored therein. Each compilation unit has an identifier stored therewith. The system also includes at least one stateless client. Each client is located on a client machine and is in communication with the repository over a network. In addition, each client has a plurality of computer readable instructions. One instruction includes receiving one or more compilation units from the repository in response to a user request. Another instruction includes programmatically sending information associated with the one or more compilation units to the repository at spaced time intervals.

In yet another embodiment of the present invention, a computer readable medium is provided. The computer readable medium includes a set of instructions encoded thereto. One instruction includes allowing a user to access a content repository on a central server over a network. Another instruction includes receiving one or more compilation units from the repository in response to a user request. Yet another instruction includes allowing a user to edit the one or more compilation units via a computer interface. Another instruction includes programmatically sending information associated with one or more compilation units to the repository at spaced time intervals.

### BRIEF DESCRIPTION OF THE DRAWINGS

FIG. 1 shows an environment in which embodiments of the present invention may operate;

FIG. 2 shows a computing device on which instructions in accordance with embodiments of the present invention may be executed;

FIG. 3 shows a source code repository according to one or more embodiments of the present invention;

FIG. 4 shows a user client interface according to one or more embodiments of the present invention; and

FIG. 5 shows a method for editing centralized source code via a stateless client on a client machine in accordance with at least one embodiment of the present invention.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

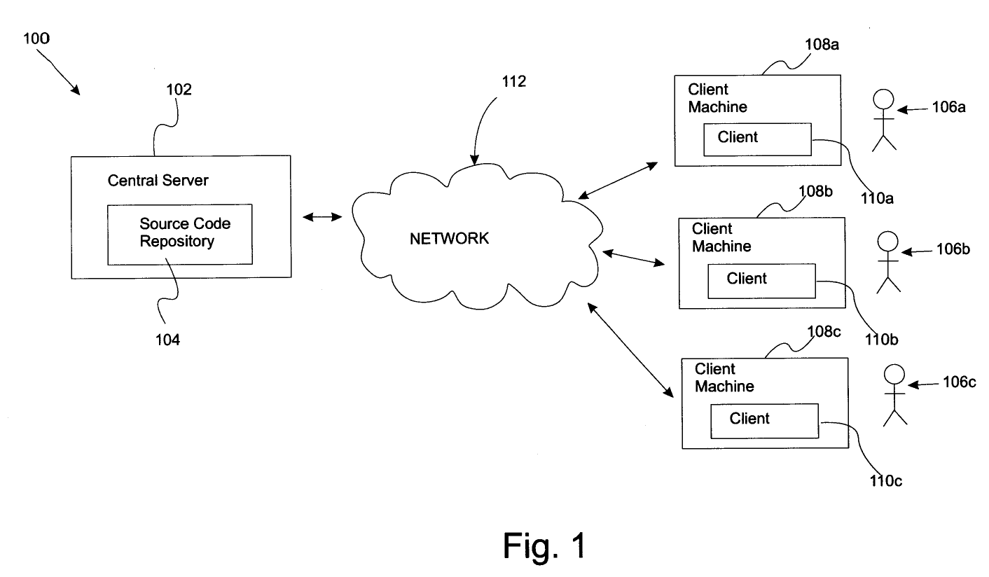

With reference to FIG. 1, system 100 is shown for accessing and editing centralized digitally encoded content. In the specific variation which is illustrated in FIG. 1, the digitally encoded content is program source code. It will readily be appreciated by those skilled in the art that the methods and details of the invention extend to any type of content that is to be collaboratively worked on by a plurality of users. Examples of such content include, but are not limited to, program source code as used in programming languages such as C, C++, Java, Fortran, and the like. The present invention is also useful for the development of projects based on scripting languages such as JavaScript and VBScript. and for the development of projects utilizing markup languages such as HTML and XML.

Still referring to FIG. 1, system 100 includes central server 102 having a source code repository 104. (In the general case, this will be a digitally encoded content repository). One or more users, generally designated by 106a-c, access corresponding clients machines, generally designated by 108a-c. Each client machine 108a-c includes at least one client interface 110a-c having access to the source code repository 104 via network 112.

Network 112 may be any suitable type of network including, but not limited to, the Internet, an intranet, and combinations thereof. As such, network 112 may span any suitable geographic distance. In a variation of the present embodiment, network 112 is a local area network (“LAN”) or a wide area network (“WAN”). For example, each client interface 110a-c may communicate with the source code repository 104 over the Internet. One skilled in the art will recognize that network 112 may include a variety of hardware and software implementations known to those skilled in the art.

In a variation of the present embodiment, system 100 is suitably used to allow one or more users 106 to edit source code located in the source code repository 104 via client interfaces 110.

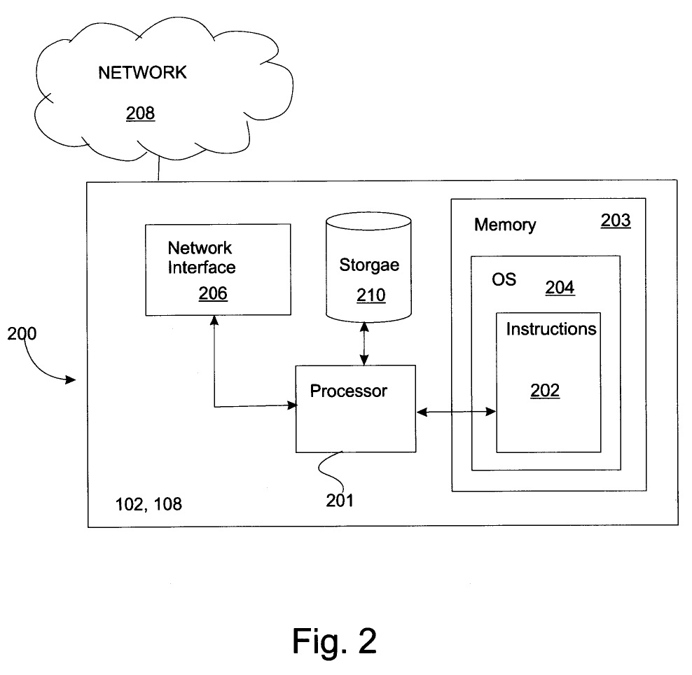

With reference to FIG. 2, a computing device is shown on which instructions in accordance with embodiments of the present invention may be executed. In a refinement of this variation, the computing device, generally designated by 200, corresponds to the central server 102 and/or any client machines 108a-c set forth above in connection with the description of FIG. 1. Computing device 200 typically includes computer processor 201 that is operative to execute programmed instructions 202 out of an instruction memory 203. The instructions 202 executed in performing the functions herein described may include instructions stored within program code considered part of an operating system 204, instructions stored within program code considered part of an application, or instructions stored within program code allocated between the operating system 204 and the application. Memory 203 may comprise random access memory (RAM), read only memory (ROM), or a combination of RAM and ROM. In another refinement, computing device 200 includes a network interface 206 for coupling the computing device 200 to the network 208. The network 208 corresponds to the network 112 shown in FIG. 1. The computing device 200 may optionally include a secondary storage device 210 such as a disk drive, a tape drive, or any other suitable secondary storage device.

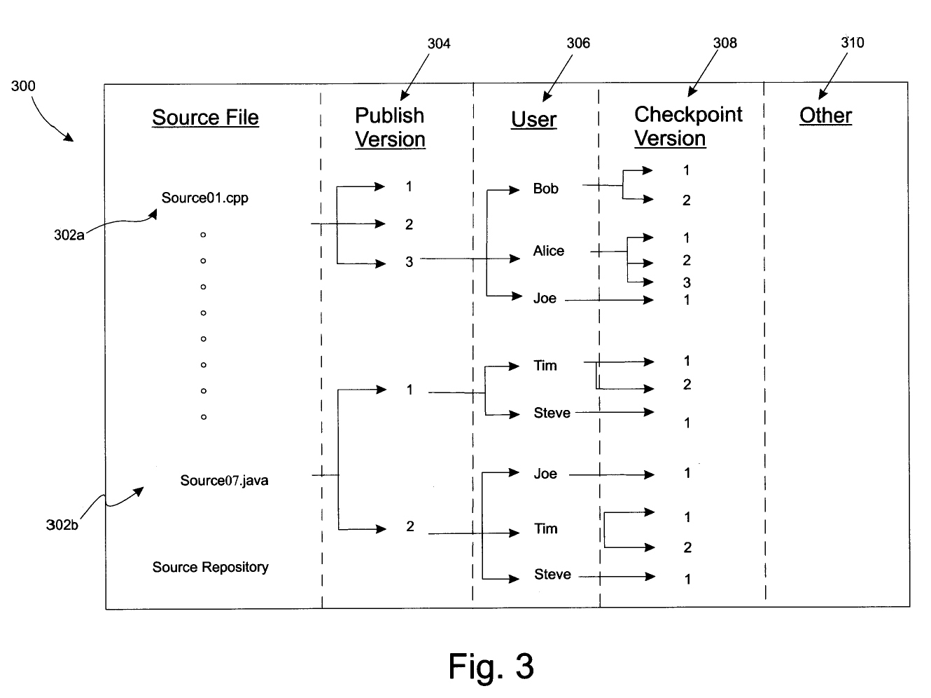

With reference to FIG. 3, exemplary source code repository 300 is shown in accordance with at least one embodiment of the present invention. Repository 300 includes a plurality of source compilation units, generally designated by numeral 302. As used herein, compilation units means component files or portions of the digitally encoded content. In this example, they would be the source code files or parts thereof being worked on. For diagrammatic simplicity, two source compilation units 302a and 302b are shown. In the example depicted in FIG. 3, source compilation units 302 are sometimes also referred to as source units or source code. It should be appreciated that in this context, compilation unit means any digitally encoded content or portion thereof that is worked on by a user.

Each source unit 302 includes one or more associated identifiers. As shown in FIG. 3, source units 302a-b may have an associated published version 304, user 306, check point version 308, and other related identifiers 310. One skilled in the art will recognize that the source units 302a-c may include a variety of other conventional identifiers such as modified time, file size, and the like.

A “published” source code version refers to source code loaded to the source repository by one or more users. “Publishing” a source unit refers to saving source code from a client interface to the source repository. In this manner, a user can edit source code from a client (e.g. client 110 shown in FIG. 1) requiring little or no “state” information and develop the source code among a community of users. Maintaining published versions 304 further allows source code repository 300 to maintain an editing history for a given source unit 302. For example, source unit 302a, entitled “Source 01.cpp”, has three published versions associated therewith, respectively numbered “1,” “2,” and “3.” Each published version 304 may be a modified version of the source code 302 and may have been edited by one or more users. As further illustrated, the third published version of source unit 302a associates with three hypothetical users, respectively “Bob,” “Alice,” and “Joe.” Each user may have individually or together contributed to the publishing of source file 302a, published version “3.”

If two or more users edit a particular source compilation unit 302 in a given time interval, resulting in two or more modified source units, the repository 300 consolidates changes made by the two or more users. In one variation, the repository 300 may cross-reference each of the two or more modified source units to the original source unit to determine changes made and resultantly publish a single source unit having the changes from each modified source unit incorporated therein. In another variation, the repository 300 may publish each of the two or more modified source units and notify subsequent source repository users in any suitable manner. One skilled in the art will recognize that conflict handling for a source unit edited by two or more users in a given time interval may be accommodated in a variety of ways. The aforementioned variations are not intended to limit the spirit or scope of the present invention.

Still referring to FIG. 3, each user 306 may have one or more associated check point versions 308. A checkpoint version may be a version of a source unit 302 that is being edited by a user which is saved to the source code repository in an automatic manner. For example, referring to source unit 302a, the user Alice has three associated check point versions. In one variation, the check point versions may be programmatically saved to the source code repository at spaced time intervals. In this manner, a source unit being edited by a client interface user can be automatically saved. Referring briefly to FIG. 1, Alice may, for example, be editing a source compilation unit from repository 104 via client interface 110a. A checkpoint version may be updated to the repository at spaced time intervals. Diverting to FIG. 3, checkpoint versions “1,” “2,” and “3” corresponding to source unit 302a, published version 2 may be such automatically saved versions. In this manner, if Alice incurs a problem, such as the client interface 110a or the client machine 108a unexpectedly crashing, she can still recover the most recent checkpoint version of the source unit.

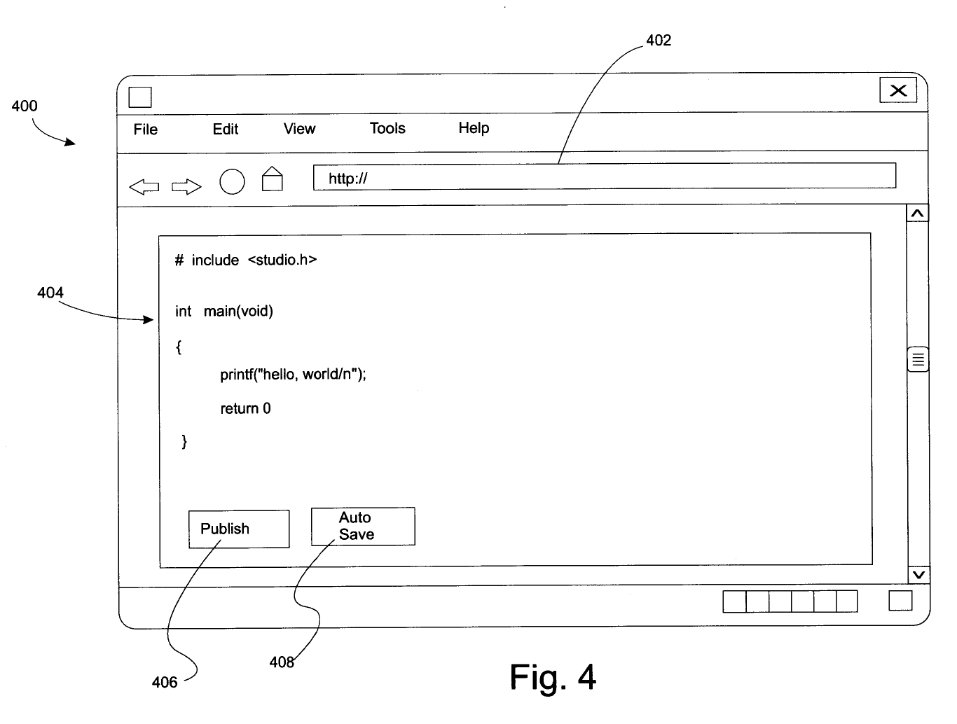

With reference to FIG. 4, an exemplary user client interface 400 is shown in accordance with at least one embodiment of the present invention. Client interfaces 400 generally correspond to each client interface 110 shown in FIG. 1. Client interface 110 preferably does not require a substantial amount of information relating to the editing of one or more source units to be saved to the hosting client machine. In this manner, a source code repository can be maintained through a plurality of users at a centralized location and may be used irrespective of a particular set of operating conditions at a given client machine.

As shown in FIG. 4, interfaces 400 may be functionally implemented via a browser. A variety of browsers are known in the art and the client interface may accordingly be implemented using any suitable browser as one skilled in the art will recognize. The user may in one variation access source code repository 104 by inputting a uniform resource locator (“URL”) address into the address bar field 402 and access a particular source unit from the source repository 104. A sample source unit is shown in the web browser window 404. In this manner, the user can edit source code from the source code repository via web browser 400.

In another variation, the client interface 110 shown in FIG. 1 may be a program that allows the user to access one or more source units from the repository, edit the one or more source units, and publish the one or more units to the repository 104. One skilled in the art will recognize that accessing, editing, and publishing source units may be accomplished in a number of ways. For example, browser scripts may be used to allow a user to edit source code in a so-called web applet. The aforementioned examples and variations are merely exemplary and are not meant to limit the spirit and scope of the present invention.

With reference to FIG. 4 and FIG. 3, web browser 400 may allow the user to publish the code or automatically save the code. Both publishing and automatically saving may be done programmatically or manually by the user. In one variation, the web browser 400 may include a published link 406 and an autosave link 408 to accomplish said respective functions. Although not shown, the user may dictate whether or not automatic saving of checkpoint versions to the source repository should take place. The user may further dictate the frequency at which the checkpoint versions are saved.

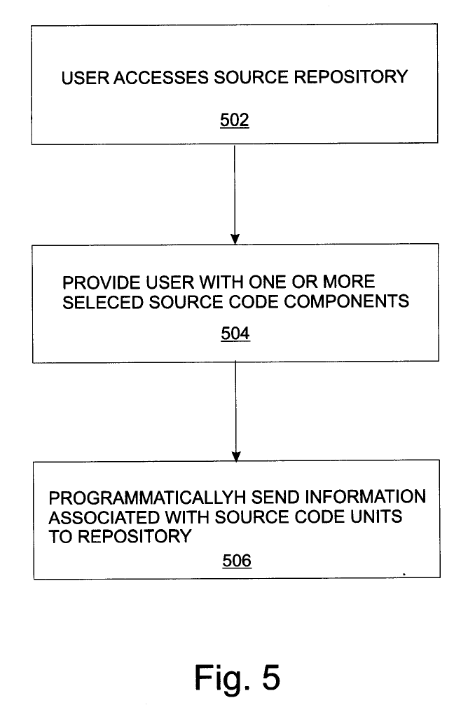

Referring now to FIG. 5, a method is for editing source code located on a central server via one or more statement clients on respective client machines is illustrated. As shown in box 502, a user accesses a source code repository on the central server. As previously shown and described, the repository includes a plurality of source units stored therein. Next, at shown in box 504, the user is provided with one or more source compilation units selected by the user via a stateless client on a client machine. In this context, “stateless client” means that the central server is able to reconstruct the digitally encoded content without relying on any client machines (e.g. client computer systems) if necessary. As previously described, the client is in communication with the source code repository over a network. Finally, as set forth in box 506, information associated with the one or more selected source compilation units is programmatically sent to the source code repository at spaced time intervals. In this manner, one or more users can edit one or more source compilation units at a centralized location via stateless clients. It should be appreciated that the steps of the method of this embodiment are executed by a computer processor, acting on the digitally encoded content. The digitally encoded content and steps encoding the methods of the invention may exist in volatile memory, non-volatile memory or a combination of both volatile and non-volatile memory. In particular, the method of this embodiment is executed by microprocessor-based or mainframe systems. Examples of media that may contain the digitally encoded content and encoded steps include, but are not limited to, RAM, hard drives, magnetic tape drives, CD-ROM, DVD, optical drives, and the like.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for editing digitally encoded content located on a central server, the method comprising:
(a) accessing by a user a content repository on the central server, the content repository having a plurality of compilation units stored therein;
(b) providing to the user via a stateless client on a client machine one or more compilation units selected by the user, the client being in communication with the repository over a network; and
(c) programmatically sending information associated with the one or more selected compilation units to the repository at spaced time intervals.

2. The method of claim 1, wherein the stateless client operates via a web browser interface.

3. The method of claim 1, wherein the stateless client does not store substantial information associated with the one or more selected compilation units to the client machine.

4. The method of claim 1, wherein the information associated with each compilation unit includes a modified compilation unit version.

5. The method of claim 4, wherein each compilation unit includes an original version number associated therewith and step (c) includes sending modified version numbers different from each respective original version number along with each modified compilation unit version.

6. The method of claim 1 further comprising the step of:
(d) determining at the central server if other users are accessing any of the compilation units in a time interval, each compilation unit accessed by multiple users in the time interval defining a multiple access unit; and
(e) resolving conflicts for each multiple access unit.

7. The method of claim 1, wherein each compilation unit in the repository has an associated original version number, the method further comprising the steps of:
(d) sending one or more modified compilation units and one or more corresponding modified version numbers to the content repository in response to a user publish request, the one or more modified compilation units defined by modified versions of the selected compilation units; and
(e) storing each modified compilation unit and associated modified version number to the repository.

8. The method of claim 7, wherein each modified version number differs from the corresponding original version number.

9. A system for editing centralized digitally encoded content, the system comprising:
a content repository stored to a central server, the repository having a plurality of compilation units stored therein, each compilation unit having an identifier stored therewith;
at least one stateless client, each client located on a client machine and in communication with the content repository over a network, each client having computer readable instructions for:
receiving one or more compilation units from the repository in response to a user request; and
programmatically sending information associated with the one or more compilation units to the repository at spaced time intervals.

10. The system of claim 9, wherein the stateless client operates via a web browser interface.

11. The system of claim 9, wherein the stateless client does not store substantial information associated with the one or more selected compilation units to the client machine.

12. The system of claim 9, wherein the information associated with each compilation unit includes a modified compilation unit version and a modified identifier.

13. The system of claim 9, wherein the content repository has computer readable instructions associated therewith for:
determining if a compilation units is being accessed by multiple users in a time interval, each compilation unit accessed by multiple users in the time interval defining a multiple access unit; and
resolving conflicts for each multiple access unit.

14. The system of claim 9, wherein each client further includes computer readable instructions for:
sending one or more modified compilation units and one or more corresponding modified version numbers to the content repository in response to a user publish request, the one or more modified compilation units defined by modified versions of the selected compilation units; and
storing each modified compilation unit and associated modified version number to the repository.

15. The method of claim 14, wherein each modified version number differs from the corresponding original version number.

16. A computer readable medium comprising a set of instructions encoded thereto, the set of instructions including instructions for:
allowing a user to access a content repository on a central server over a network;
receiving one or more compilation units from the content repository in response to a user request;
allowing a user to edit the one or more compilation units via a computer interface; and
programmatically sending information associated with the one or more compilation units to the content repository at spaced time intervals.

17. The method of claim 16, wherein each instruction is executed via a web browser interface.

18. The method of claim 16, wherein substantial information associated with the one or more selected compilation units is not stored to the computer readable medium.

19. The method of claim 16, wherein the information associated with each compilation unit includes a modified compilation unit version.

20. The method of claim 16, wherein each compilation unit includes an original version number associated therewith.
